(19) United States
(12) Patent Application Publication
(10) Pub. No.: US 2004/0125336 A1
(43) Pub. Date: Jul. 1, 2004

(54) Reading glasses

(76) Inventor: Minoru Mitamura, Sabae City (JP)

Correspondence Address: Alan D. Kamrath, Rider Bennett, LLP, Suite 2000, 333 South Seventh Street, Minneapolis, MN, 55402, US

(21) Appl. No.: 10/676,582

(22) Filed: Oct. 1, 2003

(30) Foreign Application Priority Data
Dec. 26, 2002 (JP) U2002-8488

(51) Int. Cl. G02C 7/02

(52) U.S. Cl. 351/159

(57) ABSTRACT

New pattern reading glasses are provided of the present invention. The reading glasses indicate lenses put into a lens frame of single vision reading glasses. An optical center of lenses located at the cutting line of an upper rim of the lenses, which ranges from 2 mm above and 2 mm below thereof. With the single vision reading glasses, no matter if your are looking at close scenery by the lenses or looking at distant scenery by the naked eye, the variation of interlaced images is reduced when an image is watched by the naked eye and by lenses alternately. Therefore, the reading glasses provide more comfortable eyesight.

### BACKGROUND OF THE INVENTION

1. Field of the Invention

The invention relates in general to reading glasses, and more particularly to reading glasses having an optical center of lenses located at the middle of a cutting line of an upper rim of the lenses, which ranges from 2 mm above and 2 mm below thereof.

2. Description of the Related Art

With reference to FIG. 5 to FIG. 8, a structural diagram of the general reading glasses 13 is shown. The reading glasses 13 include a middle beam 2 with nose pads 4, and also two ends of the middle beam 2 are coupled to two lenses 1. Outer sides of the two lenses 1 are coupled to the foot stands 3.

Generally, when the reading glasses 13 are put on, as shown in FIG. 3, the position 10 of a pupil of the eye is slightly higher than a cutting line 5 of an upper rim of the lenses. And also with reference to FIG. 4, when looking at close scenery, a line of vision 11 would be downward to view through the lenses 1. In contrast, when looking at farther scenery, a line of vision 12 would turn upward over the lenses 1, so as to view with the naked eye.

However, as shown in FIG. 2, an optical center 7 of the conventional reading glasses is approximately near a center point of between the upper and lower rim of the lenses 1. Therefore, when watching at the same scenery with naked eyes and with lenses 1 alternately, the scenery presents interlaced images.

Accordingly, written words on a paper are taken as an example. When looking at words 16 by the naked eye, they are presented at an actually correct position. However, when looking at the same words 15 by lenses 1, the two positions of the contents become interlaced, so as to cause uncomfortable feelings.

### SUMMARY OF THE INVENTION

In view of the above-mentioned disadvantages, it is therefore an object to provide new pattern reading glasses of the present invention. With the single vision reading glasses, no matter if you are looking at close scenery by the lenses or scenery that is farther away by the naked eye, variation of interlaced images is reduced when an image is watched by the naked eye and by lenses alternately. Therefore, the reading glasses provide more comfortable eyesight.

The new pattern reading glasses of the present invention includes an optical center of lenses located at a cutting line of an upper rim of the lenses, which ranges from 2 mm above and 2 mm below thereof.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows a presentation of written words, which are seen by the lenses of the new pattern reading glasses and by the naked eye.

FIG. 2 (prior art) shows a presentation of written words, which are seen by the lenses of the conventional reading glasses and by the naked eye.

FIG. 3 shows a front view of the reading glasses.

FIG. 4 shows a lateral view of the reading glasses.

FIG. 5 shows a three-dimension diagram of the reading glasses.

FIG. 6 shows a vertical view of the reading glasses.

FIG. 7 shows a front view of the reading glasses.

FIG. 8 shows a lateral view of the reading glasses.

### DETAILED DESCRIPTION OF THE INVENTION

The new pattern reading glasses are applied for general reading glasses.

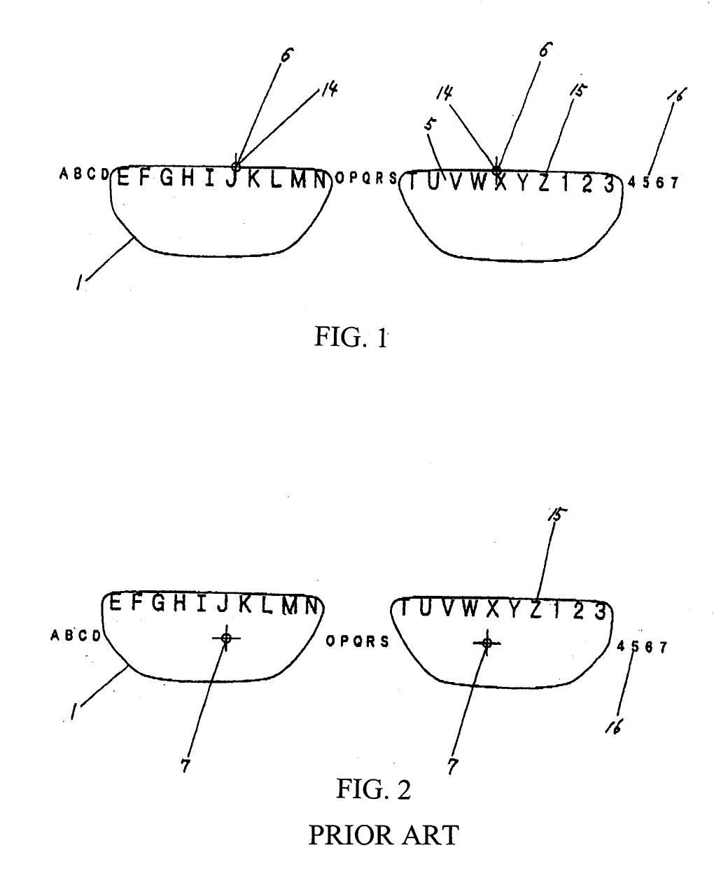

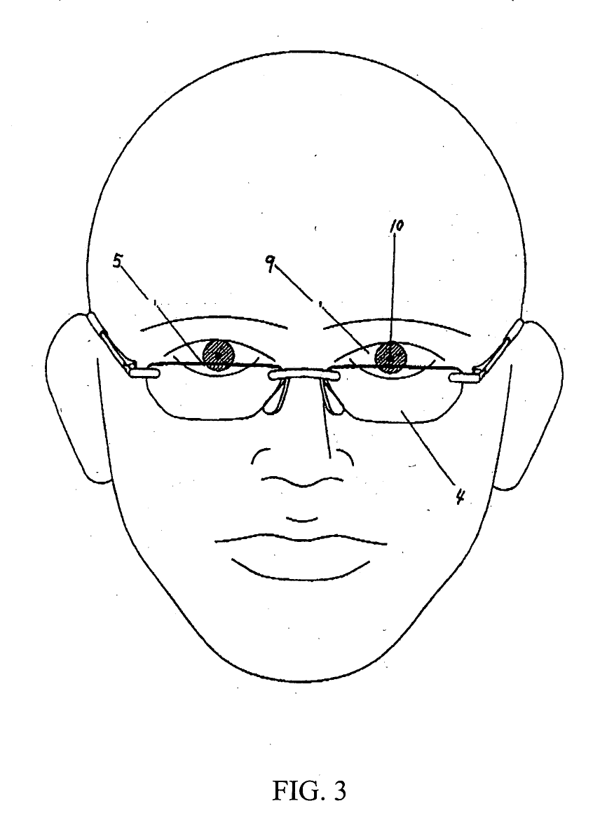

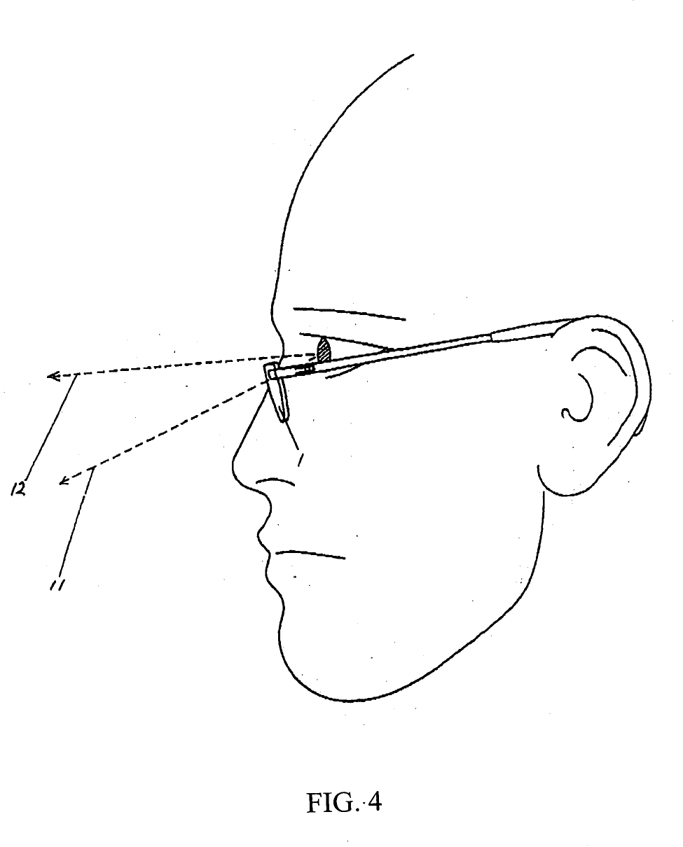

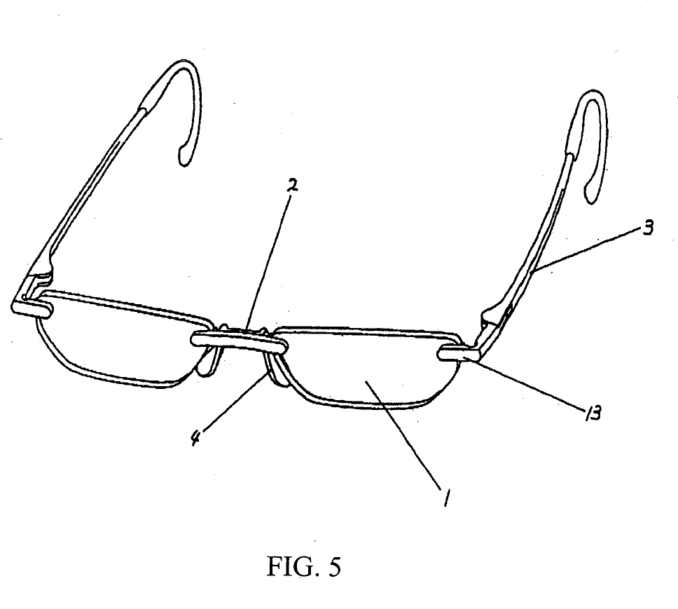

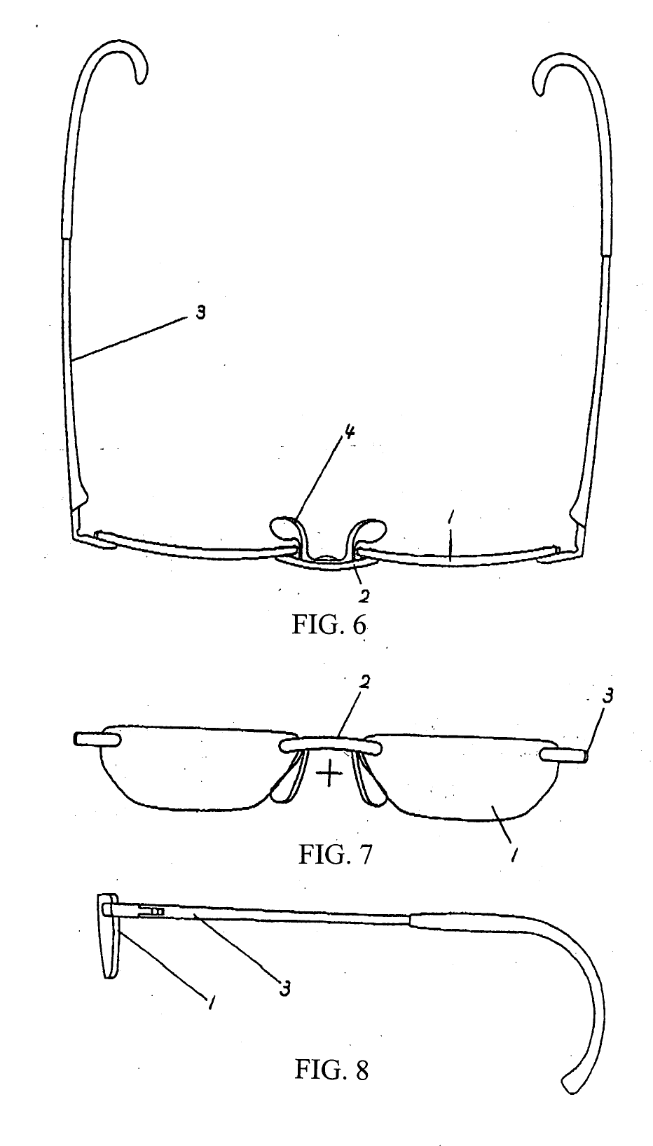

With reference to FIG. 1, an essential constructional structure of a preferred embodiment of the present invention is illustrated.

An optical center 6 of lenses of the new pattern reading glasses located at a cutting line 5 of an upper rim of the lenses 1, within a range 14 from 2 mm above and 2 mm below thereof.

The reading glasses that the lenses are put into a lens frame in this method as described above can reduce vibration of interlaced images when an image is watched by the naked eye and by the lenses alternately. Therefore, a viewer perceives a slighter sense of variation of interlaced images.

Accordingly, written words on a paper are taken as an example. Both of the contents 16 seen by the naked eye and the contents 15 seen by lenses will be presented approximately in the same horizontal row.

The new pattern reading glasses of the present invention are embodied as the above-mentioned mode. An effect of the present invention is described as follows.

With the reading glasses, no matter watching near scenery by the lenses or watching scenery far away by the naked eye, variation of interlaced images can be reduced when an image is watched by the naked eye and by lenses alternately. Therefore, the reading glasses provide more comfortable eyesight.

While the invention has been described by way of example and in terms of a preferred embodiment, it is to be understood that the invention is not limited thereto. On the contrary, it is intended to cover various modifications and similar arrangements and procedures, and the scope of the appended claims therefore should be according to the broadest interpretation so as to encompass all such modifications and similar arrangements and procedures.

What is claimed:

1. Reading glasses comprising a characteristic of having an optical center of lenses located at the middle of a cutting line of an upper rim of the lenses, which ranges from 2 mm above and 2 mm below thereof.
